(19) United States
(12) Patent Application Publication
(10) Pub. No.: US 2011/0163916 A1
(43) Pub. Date: Jul. 7, 2011

(54) SYSTEM FOR DETECTING AN OBJECT WITHIN A BUILDING OR STRUCTURE

(76) Inventor: Michael Bamidele, Kent (GB)

(21) Appl. No.: 12/853,485

(22) Filed: Aug. 10, 2010

(30) Foreign Application Priority Data
Jan. 7, 2010 (GB) GB1000158.4

(51) Int. Cl. G01S 5/02

(52) U.S. Cl. 342/451

(57) ABSTRACT

A system for locating objects within a building having walls. The system incorporates the use of electronic identification tags that wireless communicate with both a stationary base device and a movable handheld device. Through triangulation, the location of the object within the building can be displayed on an electronic version of the structural diagram of the building. The system also collects and generates data during object location that can be used to provide statistical analysis related to the objects.

### FIELD OF THE INVENTION

This invention relates to the field of locating missing objects using affixed electronic tags. More particularly, the present invention relates to the use of electronic tags, a base station and a hand held device to locate an object and its affixed electronic tag within a building. Furthermore, the present invention is directed to using an electronic copy or a building's structural diagram as a map to the location of the object and its affixed electronic tag.

### BACKGROUND OF THE INVENTION

The field of location device technology is well developed. Radio Frequency Identification Tags (RFID) and other such technologies allow for objects to be located within warehouses and stockrooms. The technology is low cost and simple to implement. Electronic tags are used in a wide variety of industrial and large scale commercial enterprises. Specifically, electronic tags are used in systems and devices for tracking large shipments of raw and finished goods in transport.

While current systems and technologies are well suited towards industrial usages, they are not well positioned to assist domestic users. An example of the deficiencies that we perceive in prior art location systems can be seen in U.S. Pat. No. 7,388,491 to Chand. Chand et al. describes a system for item tagging and determining the location of an electronic tag with a portable location device. A significant drawback of Chand can be appreciated when you consider that it lacks a system for both cataloging personal items and locating them within an enclosed space or building. Furthermore, Chand also lacks the use of an electronic structural diagram to aid in the location of an object.

Another example of the prior art location systems is Mendolia et al (U.S. Pat. No. 7,183,922). Mendolia used optical and other line of sight sensors to locate an object for tracking. Mendolia, because of its line of sight sensors, fails to track objects that are located behind visual obstacles. Furthermore, Mendolia fails to allow for the item location to be displayed on a visual display with reference to an electronic blueprint or schematic. The invention addresses at least one of these drawbacks in a system that can be accessed by a home user.

### SUMMARY OF THE INVENTION

In accordance with a broad aspect of the invention, the present invention provides for an object detection system for detecting an item within a building. In more particular aspects, the present invention provides a system for locating an object within a building where the exterior walls and interior walls provide a hindrance to locating the desired object. The object detection system uses a base device or station, configured to be permanently located within a building, along with a hand-held device or scanner using, to locate an electronic tag using electronic signals triangulation. This identification tag is affixed to an object that a user might want to know the location in the future. The identification tag and the object are placed in a building. The system according to the invention is configured to enable a user to locate the desired object within the building by using a triangulation algorithm. In using this algorithm, the location of the object is able to be represented on the electronic copy of the building's structural diagram. The structural diagram of the building can be added, modified or otherwise altered by the user. It is further envisioned that the structural diagram is displayed on a handheld locator device.

The advantages of this system are apparent. The object detection system envisioned uses a calibrated base device placed at a predetermined location within a building. By calibrating a base device, a set of coordinates that have an unchanging frame of reference can be devised. This eliminates the need for extensive sensors throughout the building. Furthermore, the base device is configured to communicate with the handheld device and the item tag. This allows the user to search for the object with the handheld device while physically moving through the building. The handheld device can display an electronic copy of the structural diagram of the building as well as the item location within the building. Therefore, a user can be guided to the specific location of the object by the handheld device.

These and other aspects, features and benefits of the invention can be further appreciated from the accompanying drawings, which illustrate certain embodiments of the invention together with the detailed description thereof.

### BRIEF DESCRIPTION OF THE DRAWINGS

FIG. 1 is a schematic block diagram of a system according to one embodiment of the invention, highlighting certain interconnected elements thereof.

FIG. 2 is a conceptual diagram of a display highlighting the structural diagram and item location functions in accordance with the invention.

FIG. 3 is an illustrative diagram of the invention, highlighting the interconnected modules of system in accordance with the invention.

FIG. 4 is a set of modules that cooperate to provide functionality to a user through and display such as shown in FIG. 2, using a suitable component of the object detection system of FIG. 1.

### DETAILED DESCRIPTION OF CERTAIN EMBODIMENTS OF THE INVENTION

By way of overview and introduction, the present invention concerns a system (100) for locating an object (106) within a building by referencing an electronic version of the structural diagram (202) of the building. The system uses a base station (104), item tag[s] (108) and a handheld device (102) to locate an object (106) in a building. The system herein described employs the use of wireless communications (110) between the item tag (108)—which is affixed to desired object (106), the base device (104), and handheld device (102). A series of modules execute on a processor to configure the processor to interpret the wireless communications (110) between the devices and determine the location of the item tag through triangulation algorithms. The location is displayed on an electronic copy of the building's structural diagram (202). Using a system (100) so-constructed, a user can be directed to the physical location of the object (106).

In an illustrative embodiment of the invention, a user affixes an item tag to a specific object. A structural diagram file is created, marking the exterior walls of a building as a boundary of the building. A base station is placed at a pre-determined location within the building and is calibrated to be the origin of a coordinate system. A user who wishes to locate a specific object can search for it by using a handheld scanner device. The electronic tag communicates its location to the base station and the handheld device through wireless signals. A triangulation algorithm determines the location of the tag with respect to the base station. The handheld device is able to indicate where in on the electronic copy of the structural diagram the object is located. The user can then travel to the physical location indicated on the electronic structural diagram and retrieve the object.

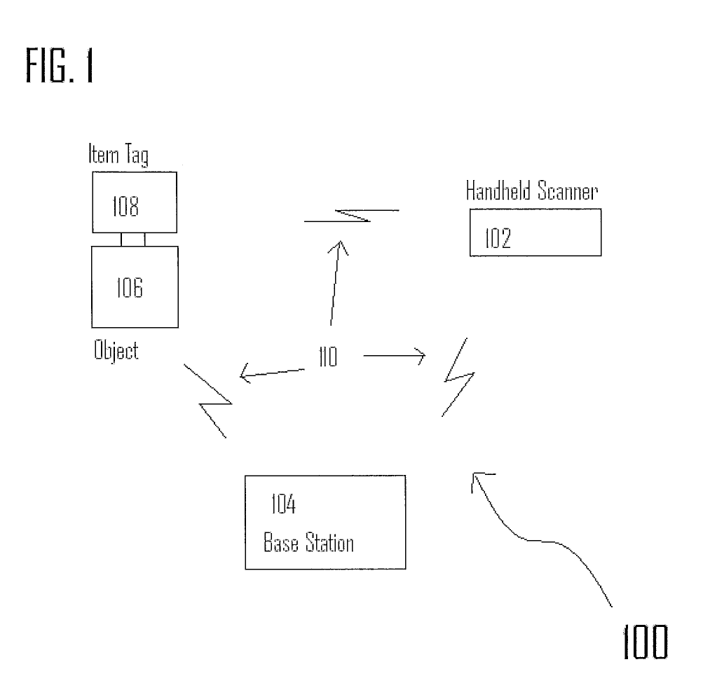

As seen in FIG. 1, the object detection system (100). The system (100) uses wireless communication protocols to communicate signals (110) between the item tag (108), the base device (104) and the handheld device (102). The base device (104), in conjunction with the handheld device (102), allows a user to triangulate the location of the object (106) in a building by locating the item tag (108). The location of the item tag (108) is then displayed as a visual marker (208) superimposed on an electronic copy of the structural diagram.

The item tag (108) can be configured to have a wireless transponder module that includes a, power source and memory (not shown). This configuration calls for an active RFID tag. The item tag (108) is connected to an object (106) whose location a user would like to monitor. The item tag (108) can be affixed to the object by adhesives, fasteners or other securing devices. The item tag (108) produces a unique identifier code or signal when in communication with the base device (104) or handheld device (102). The item tag (108), alternatively, can be achieved using a passive RFID tag in which the tag's transponder module is energized by the signal received from the base device (104) and/or handheld device (102).

The base device (104) is configured to communicate via wireless protocols (110) with both the handheld device (102) and the item tag (108). Whether active or passive, a signal received at the transponder module prompts a response from the transponder module can be in any one of a number of frequency ranges including but not limited to 125 KHz, 134 KHz, 13.56 MHz, 958 MHz, the 2.4 GHz Bluetooth standard, and at higher frequencies in accordance with any number of standards regarding RFID systems, including, by way of illustration: ISO 15693, ISO 18000 (for item-level tracking at 13.56 MHz), and ISO18000-6. The base device (104) is preferred to be placed in a location that can be suitable as the origin of a coordinate system. For instance, the base device (104) can be located at or on an exterior wall, and preferably at an exterior corner. This allows the triangulation algorithms to ignore false results that correspond to a location outside the building, as explained more fully below. Furthermore, this allows the system to more quickly process location data of multiple tags. The base device (104) is equipped with a power supply and wireless communication module that includes a transmitter. The transmitter is configured to communicate with the item tag (108) and the handheld device (102). Furthermore, the base device (104) is configured by a triangulation module to measure the communications between the devices and calculate the distance between the devices. An embodiment of the present invention has the base device (104) measuring the signal strength of the communication signals sent between the base device (106) and the item tag (108) and the base device (104) and the hand held device (102) and using that value to determine distance between the devices. A still further embodiment has the base device (104) equipped with inputs that provide the location of the handheld device (102) using a location detection module. Another embodiment of the present invention has the base device (104) equipped with a processor or computer configured to process communication between the devices and determine the location of the item tag (108) from the information in the communication stream.

The handheld device is configured to communicate via wireless protocols (110) with both the base device (104) and the item tag (108). An embodiment of the present invention has the handheld device (102) comprising software, hardware, or a combination thereof. The handheld device can be modified PDA, smart phone, tablet-style device, or any known mobile computing platform. A further embodiment of the present invention has the handheld device (102) capable of measuring the signal strength of the communication signals sent between the handheld device (102) and the item tag (108) and the base device (104) and the handheld device (102) and using that value to determine distance between the devices. For instance, an “app” executing on an iPhone or iPad by Apple Computer, Inc. can configure such a device to be the handheld device (102). A further embodiment of the present invention has the handheld device (102) equipped with a processor or computer configured to process the wireless communication between the devices and determine the location of the item tag (108) from the information in the communication stream.

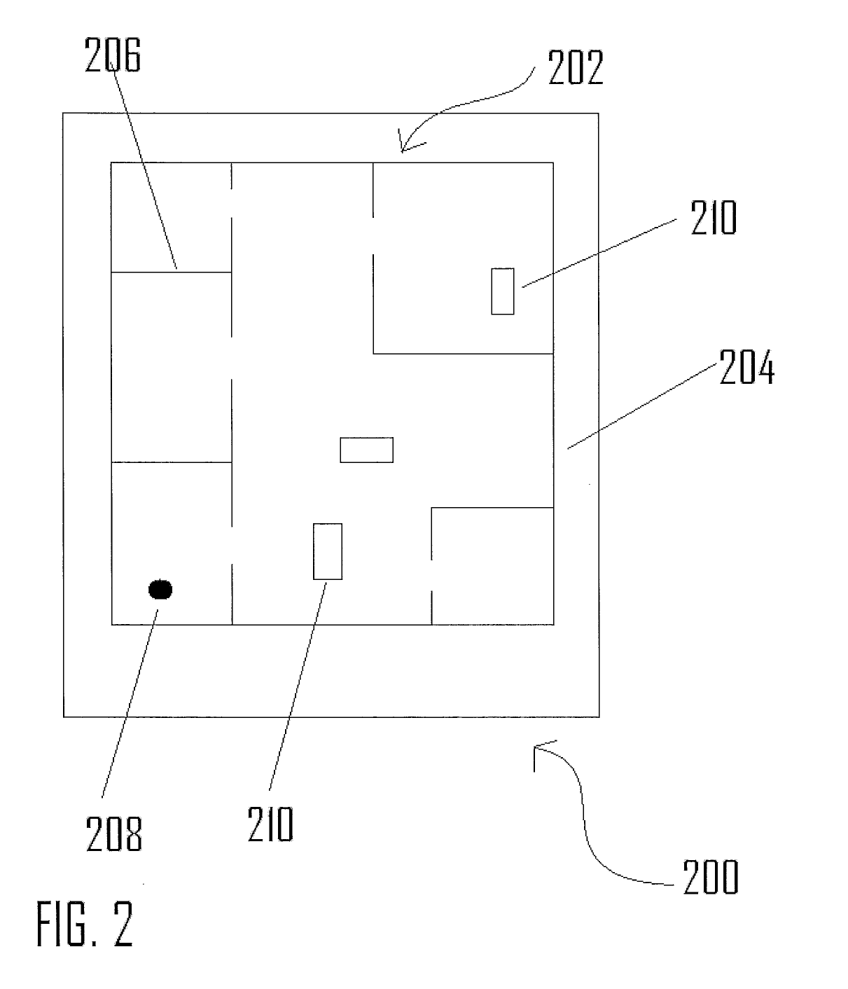

Another embodiment of the present invention has a display integrated into the handheld device (102). The display is arranged to depict the electronic copy of the structural diagram and the location of the object (106) and item tag (108) within the structural diagram (202 (see FIG. 2)).

The wireless communication protocol (110) can be any wireless signal that does not require line of sight communication and is capable of propagating through a building or structural elements. One embodiment has the communication protocol as employing the any available frequencies and characteristics of the RF spectrum. 125 KHz, 134.56 MHz, 958 MHz, the 2.4 GHz.

As seen in FIG. 2, an illustrative diagram showing the electronic structural diagram and the location of the object and item tag within the structural diagram as can be presented on a video display (200). The display (200) is configured by code or a series of modules executing on the handheld device (102), (or another device having a processor and memory to run suitable modules as described herein) to depict the structural diagram (202) of the building, including exterior walls (204), interior walls (206) and, optionally, other visual obstacles (210). Furthermore, the display (200) is so-configured to indicate where on the structural diagram the item (108) and object (106) are located. This is accomplished by using a visual marker (208) or icon on the display. The visual marker (208) can be an icon or a basic geometric shape. Alternative embodiments of the present invention can have the visual marker (208) as a complex shape representative of the object being sought. The electronic copy of the structural diagram is uploaded to the system that is to present the results of an object query or other object tracking as an electronic file.

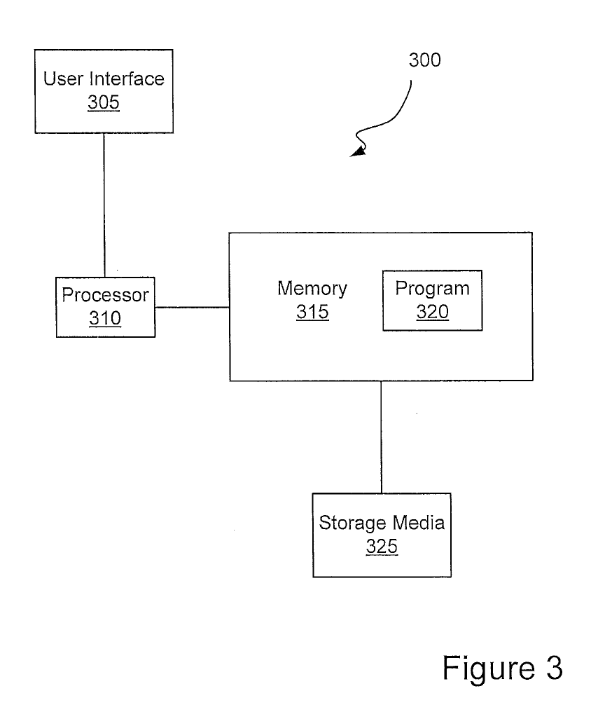

FIG. 3 is a block diagram of a computer system 300 configured for implementing portions of the system 100 as described above. System 300 includes a user interface 305, a processor 310, and a memory 315. System 300 may be implemented on a general purpose microcomputer, such as one of the members of the Sun® Microsystems family of computer systems, one of the members of the IBM® Personal Computer family, one of the members of the Apple® Computer family, or a myriad other conventional workstation, desktop computer, laptop computer, tablet computer, a netbook computer, a personal digital assistant, or a smart phone. Although system 300 is represented herein as a standalone system, it is not limited to such, but instead can be coupled to other computer systems via a network (not shown).

Memory 315 is a memory for storing data and instructions suitable for controlling the operation of processor 310. An implementation of memory 315 could include a random access memory (RAM), a hard drive and a read only memory (ROM). One of the components stored in memory 315 is a program 320.

Program 320 includes instructions for controlling processor 310 to execute steps in support of the system 100. Program 320 may be implemented as a single module or as a plurality of modules that operate in cooperation with one another. Program 320 is contemplated as representing a software embodiment of the system and method described hereinabove.

User interface 305 includes an input device, such as a keyboard, touch screen, tablet, or speech recognition subsystem, for enabling a user to communicate information and command selections to processor 310. User interface 305 also includes an output device such as the display 200 or a printer. In the case of a touch screen, the input and output functions are provided by the same structure. A cursor control such as a mouse, track-ball, or joy stick, allows the user to manipulate a cursor on the display for communicating additional information and command selections to processor 310.

While program 320 is indicated as already loaded into memory 315, it may be configured on a storage media 325 for subsequent loading into memory 315. Storage media 325 can be any conventional storage media such as a magnetic tape, an optical storage media, a compact disc, or a floppy disc. Alternatively, storage media 325 can be a random access memory, or other type of electronic storage, located on a remote storage system.

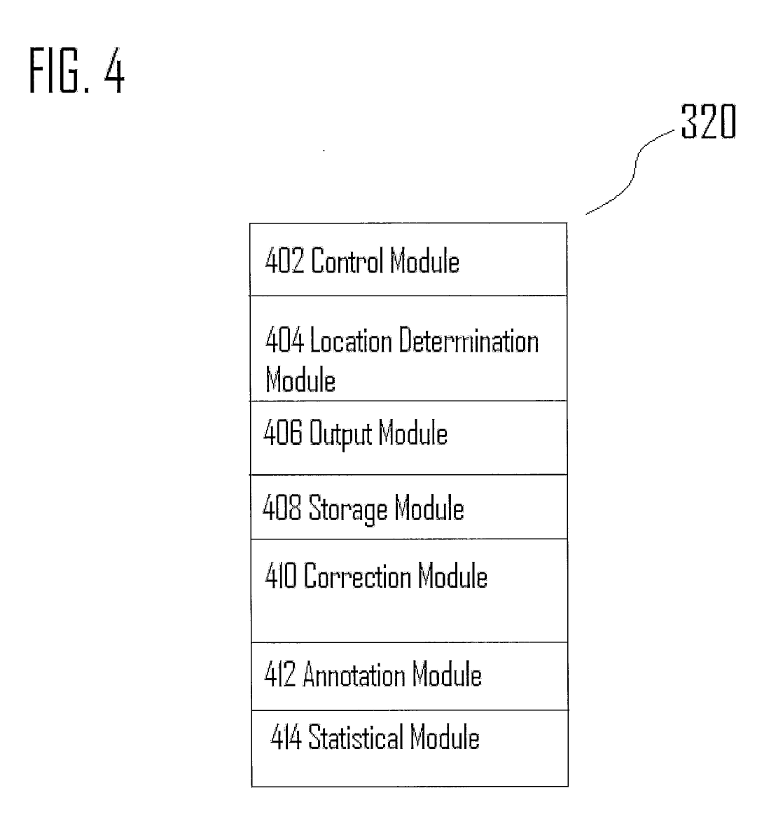

The object detection system provides a user with the ability to search for a specific item tag and to locate that item tag, and its associated object, within a building by displaying the location as a visual marker, overlaid on a structural diagram. More specifically, as shown in FIG. 4, a set of modules cooperate with one another to provide the location of the item tag on the structural diagram (202) depicted in FIG. 2. Thus, for example, there is an access module (402), a location determination module (404), an output module (406), a storage management module (408), a correction module (410), an annotation module (412), and a statistical module (414). Each of these modules can comprise hardware, code executing in a processor, or both, that configures a machine such as the base device (104) or the handheld device (102) to implement the functionality described herein.

With further reference to FIG. 4, the control module (402) includes instructions for enabling a user to access the control functions of the object detection system. The control functions can be implemented as discrete sub-modules providing the ability to start or stop an item tag search, import and select a structural diagram file, calibrate the location of the base device within a home or other physical space, access user information, create look-up tables relating a specific tag to a specific object, and access stored data. As such, the access module has control over at least file management, selection of structural diagrams and initiation of item (tag) searches.

Location determination module (404) includes instructions for receiving signal data from a wireless communication module or from a database and locating the item tag (106) through triangulation. The location determination module (404) is further configured to receive data from one of the wireless communication module of the base device (104), and the wireless communication module of the handheld device (102) and an item tag (108). Of course the module executes on either the base device or the handheld device, and does not receive location related data from its own, first device. The triangulation function of the module can be implemented as discrete sub-modules to provide functions such as distance calculating algorithms based on signal strength or other parameters, correlating data to a coordinate system, comparing data received from the base device and hand held device, and determining location of the object within the coordinate system. The triangulation module receives input from the communication modules of the base device or the handheld device, the tag (108) and from data stored in a database. The triangulation module outputs a data and a coordinate system that corresponds to the location of the object (106) within the structural diagram (202).

Output module (406) includes instructions for placing a visual marker (208) corresponding to the location of the item tag in the structural diagram (202). The output module can be implemented as discrete sub-modules configured to provide the specific functions of, rendering a visual icon, calibrating the location of the visual icon with respect to the structural diagram (including adjustments for scale of the diagram), overlaying the visual icon on the structural diagram image, and forming a composite image that combines the structural diagram and the visual icon. The output module outputs the composite image to the display.

Storage management module (408) includes instructions for storing and retrieving data in the form of prior searches, a look-up table correlating objects with specific tags, stored structural diagram files, a set of visual icon shapes and figures and providing that data to the system 100. The storage management module can be remote from the system, or incorporated into it.

Correction module (410) includes instructions for checking the location of the visual marker and determining if the visual marker is located inside a structural element or other object designated as a physical boundary. The correction module can be implemented as discrete sub-modules configured to provide the specific correction functions of cross-referencing the coordinates of structural elements and comparing those coordinates to the coordinate of the item tag and correcting the visual marker placement by moving the marker next to the structural element. As such, this module operation to locate the object (106) within the exterior walls (204) defined in the diagram (202).

Annotation module (412) includes instructions for annotating the structural diagram file of the building. The annotation module can be implemented as discrete sub-modules configured to provide the specific annotation functions of adding structural elements to the structural diagram and adding non-structural, vision obstruction objects to the structural diagram. For instance, this module permits user-customization of the structural diagram (202), such as to include objects (210).

Statistical module (414) includes instruction for manipulating stored data relating to the determined locations and user data. The manipulation functions can be implemented as discrete sub-modules with instructions for providing statistical analysis as the frequency of searches, frequency of specific item tag searches, probability of object location, and other user directed statistics. For example, a user could determine the frequency of use of an object. The statistical module can also provide information about the behavior of the user, providing data on when, how and where an object is located most often. Additionally, the statistical module can determine the frequency of misplacement of a device or its product life span based on the frequency of specific user searches. A further embodiment of the present invention envisions using item tags to define the boundaries of the structural diagram using a blank structural diagram template. In some circumstances, it is not be feasible to have a user create a structural diagram. Alternatively, there are circumstances where the structural diagram is no longer accurate, as in the case of home modification, and needs to be amended to add additional rooms. In these circumstances, the communication between the base device (104), item tag (108) and handheld device (102) can be used to define the boundaries in the structural diagram. If the user is generating a completely new structural diagram, a set of specific tags (108) are placed in the corners of any room or building that needs to be included in a structural diagram. A user must then ensure that the base device (104) is secured, preferably in an exterior corner of a structure, and indicate its location on a new structural diagram template. Alternatively, if a user is modifying an existing structural diagram, the user merely activates the annotation module (412) of the system 100. A user can then use at least 3 item tags (108) to define the exterior boundaries of the new room or structure within the structural diagram by communicating with the base device (104). The tags (108) correspond to the X, Y & Z coordinates of the 4 corners (in 2 dimensional format) or 8 corners (in 3 dimensional format) of each room relative to the base device (104). By calibrating the system to interpret the 3 or more calibrated tags (108) as exterior corners of the building or room, the system can then automatically generate boundaries on the structural diagram, correlated to walls in the building, by using basic geometric algorithms distance data from the base device (104) and handheld device (102). This calibration can be repeated in other rooms to build up a complete complex structural diagram of the desired building. A user can then make the necessary annotations on the structural diagram via any input device accessible by the system.

Additionally, the tags (108) can be used to calibrate distance calculations made by the algorithm. If a distance between a tag and the base device (104) is known, a user can place a tag (108) in a corner of a building or room and enter the straight line distance between the tag (108) location and the base device (104). This distance can be then used to calibrate the other tags (108) to generate a structural diagram of the building or room.

It is possible to envision all of the disclosed features and capabilities of the present invention as software modules. These software modules are stored as computer code and are executable by a processor or computer system to configure the host processor so as to implement the functionality described herein.

The system described herein have been indicated in connection with the diagrams that facilitate a description of the principal processes; however, certain modules can be invoked in an arbitrary order, such as when the events drive the program flow such as in an object-oriented program. Accordingly, the diagrams are to be understood as presenting blocks that can be invoked in a different order than as illustrated.

It should be understood that various combination, alternatives and modifications of the present invention could be devised by those skilled in the art. The present invention is intended to embrace all such alternatives, modifications and variances that fall within the scope of the appended claims.

While the invention has been particularly shown and described with reference to preferred embodiments thereof, it will be understood by those skilled in the art that various changes in form and details may be made therein without departing from the spirit and scope of the invention.

I claim:

1. An object detection system for detecting an item within a building, wherein the building has walls, the object detection system comprising:
an image file depicting a structural diagram of the building and demarking a boundary defined by the walls;
a tag connectable to an object;
a base device located within the building and within the boundary and being in communication with the tag;
a hand-held locator device configured to communicate with the base device and at least one tag;
a computer having a processor, a database, and a display;
a plurality of modules executing in the processor so as to configure the computer to:
access data from an access module;
determine a location of the tag by using a triangulation algorithm included in a location module,
output a composite image depicting the tag location as a visual marker superimposed on the structural diagram using a rendering module;
wherein the database is in communication with at least one of the aforesaid modules so as to store tag data and location data.

2. An object detection system as in claim 1, further comprising, among the plurality of modules, an annotation module operative to accept user-input to demark one or more obstacles within the boundary in regard to the image file.

3. An object detection system as in claim 1, wherein the plurality of modules executing in the processor further comprises:
a statistical analysis module operative to process data from the database and to output a statistical analysis of the data.

4. An object detection system as in claim 1, wherein the plurality of modules executing in the processor further comprises:
a correction module operative to process data correlated to the location of the visual marker when a first determined location is determined to conflict with the boundary or other structural element demarked in regard to the image file and provide a corrected, second determined location.

5. An object detection system of claim as in claims 1, wherein the rendering module is capable of depicting more than one visual marker.

6. An object detection system as in claim 1, wherein the triangulation algorithm of the location module uses data from the hand-held device and the base device to calculate the location of the tag.

7. An object detection system as in claim 1, wherein the image file of the structural diagram is a two-dimensional diagram.

8. An object detection system as in claim 1, wherein the image file of the structural diagram is a three-dimensional diagram.
